(19) United States
(12) Patent Application Publication
(10) Pub. No.: US 2023/0080081 A1
(43) Pub. Date: Mar. 16, 2023

(54) SULFIDE SOLID ELECTROLYTE, METHOD OF PRODUCING THE SAME AND ALL-SOLID-STATE BATTERY COMPRISING THE SAME

(71) Applicants: Hyundai Motor Company, Seoul (KR); Kia Corporation, Seoul (KR)

(72) Inventors: Yong Sub Yoon, Seoul (KR); Hajime Tsuchiya, Yokohama (JP); Yuki Sasaki, Yokohama (JP); Hironari Takase, Yokohama (JP)

(21) Appl. No.: 17/943,856

(22) Filed: Sep. 13, 2022

(30) Foreign Application Priority Data
Sep. 16, 2021 (KR) 10-2021-0123750

(51) Int. Cl. H01M 10/0562; H01M 4/38; H01M 10/052

(52) U.S. Cl. CPC H01M 10/0562; H01M 4/382; H01M 10/052; H01M 2004/027

(57) ABSTRACT

Disclosed are, inter alia, a sulfide solid electrolyte, a method of producing the same, and an all-solid-state battery including the same.

### CROSS-REFERENCE TO RELATED APPLICATION

This application claims, under 35 U.S.C. § 119(a), the benefit of priority to Korean Patent Application No. 10-2021-0123750 filed on Sep. 16, 2021, the entire contents of which are incorporated herein by reference.

### TECHNICAL FIELD

The present invention relates to a sulfide solid electrolyte, a method of producing the same, and an all-solid-state battery including the same.

### BACKGROUND

Nowadays, secondary batteries have been widely used in large devices such as automobiles and electric power storage systems as well as in small devices such as mobile phones, camcorders and notebook computers.

As the range of application of secondary batteries broadens, there is increasing demand for safe and highly functional batteries. For example, lithium secondary batteries, which are one type of secondary battery, have advantages of high energy density and high capacity per unit area compared to nickel-metal hydride batteries or nickel-cadmium batteries. However, the electrolytes conventionally used in lithium secondary batteries are liquid electrolytes such as organic solvents. Accordingly, safety problems such as leakage of electrolyte and risk of fire may continue to occur.

Accordingly, recently, all-solid-state batteries which utilize solid electrolytes, rather than liquid electrolytes, as electrolytes to improve the safety of lithium secondary battery are attracting much attention.

Solid electrolytes are safer than liquid electrolytes due to the non-combustible or flame-retardant nature thereof. Solid electrolytes are classified into oxide solid electrolytes and sulfide solid electrolytes. Sulfide solid electrolytes are generally used because they have greater lithium ionic conductivity and are stable across a wider voltage range than oxide solid electrolytes. However, sulfide solid electrolytes have a drawback of unstable operation of batteries because they have lower chemical stability than oxide solid electrolytes.

In the related art, a sulfide solid electrolyte material made of a glass ceramic and containing Li, P, S, and I has been reported. The result of X-ray diffraction (XRD) reported in Patent Document 1 showed that the sulfide solid electrolyte material is a mixture of a Li₃PS₄ glass ceramic and LiI.

Moreover, in the related art, an inorganic sulfide in which crystalline and glass phases coexist and which is represented by dLi₂S-eMS₂-fLiX-(1-d-e-f)P₂S₅, wherein X represents at least one selected from the group consisting of Cl, Br and I, M represents at least one selected from the group consisting of Ge, Sn, and Ti, and d, e, and f satisfy 0.600≤d≤0.860, 0≤e≤0.333, 0≤f≤0.300, and 0.600≤d+e+f≤1. For example, the inorganic sulfide may be a composite in which a Li₄PS₄I crystal phase and a Li₂S—P₂S₅ glass phase coexist.

The above information disclosed in this Background section is provided only for enhancement of understanding of the background of the invention and therefore it may contain information that does not form the prior art that is already known in this country to a person of ordinary skill in the art.

### SUMMARY

In preferred aspects, provided is a sulfide solid electrolyte having excellent lithium ion conductivity and/or capable of remarkably reducing interfacial resistance with other components.

The objects of the present invention are not limited to those described above. The objects of the present invention will be clearly understood from the following description, and may be implemented by means defined in the claims and a combination thereof.

In one aspect, methods are provided for preparing a sulfide solid electrolyte, a method suitably comprising: (a) calcining a solid electrolyte precursor to prepare a crystalline solid electrolyte represented by the following formula: Li₄₊ₓPS₄I₁₊ₓ (−0.1≤x≤0.1); and (b) treating the crystalline solid electrolyte to obtain a particulate solid electrolyte. The crystalline solid electrolyte suitably may be treated by mechanical force to obtain a particulate solid electrolyte, for example the crystalline solid electrolyte may be pulverized to obtain a particulate solid electrolyte.

In a further aspect aspect, provided is a method of preparing a sulfide solid electrolyte. The method may include providing a solid electrolyte precursor, pulverizing the solid electrolyte precursor, calcining the pulverized solid electrolyte precursor to prepare a crystalline solid electrolyte represented by the following Formula 1, and pulverizing the crystalline solid electrolyte to obtain a particulate solid electrolyte.

Li₄₊ₓPS₄I₁₊ₓ (−0.1≤x≤0.1) [Formula 1]

The solid electrolyte precursor may include a compound or elemental substance including at least one of lithium (Li), phosphorus (P), sulfur (S), and iodine (I) elements.

The pulverized solid electrolyte precursor may be calcined at a temperature of about 200° C. to 500° C.

The crystalline solid electrolyte may be converted to a particulate solid electrolyte through pulverization at about 300 rpm to 500 rpm for about 10 minutes to 2 hours.

When measured by Raman spectroscopy, a position of a center of a maximum peak of the particulate solid electrolyte may be shifted by about −0.5 cm⁻¹ or greater from a position of a center of a maximum peak of the crystalline solid electrolyte.

When measured by Raman spectroscopy, a full width at half maximum (FWHM) of the maximum peak of the particulate solid electrolyte may increase by about 20% or greater compared to a full width at half maximum (FWHM) of the maximum peak of the crystalline solid electrolyte.

When measured by Raman spectroscopy, the particulate solid electrolyte may have a maximum peak at 425.9±0.50 cm⁻¹ and a full width at half maximum (FWHM) of the maximum peak of 6.9±0.50 cm⁻¹.

The particulate solid electrolyte may have peaks at 2θ=14.9°±0.50°, 18.3°±0.50°, 21.1°±0.50°, 28.0°±0.50°, 32.0°±0.50°, 33.5±1.00°, 36.8°±1.00°, and 38.6°±1.00° when measuring an X-ray diffraction (XRD) pattern using CuKα rays.

The particulate solid electrolyte may have a lithium ion conductivity of about 1.0 mS/cm or greater.

In another aspect, provided is a sulfide solid electrolyte represented by the following Formula 1 and having peaks at 2θ=14.9°±0.50°, 18.3°±0.50°, 21.1°±0.50°, 28.0°±0.50°, 32.0°±0.50°, 33.5±1.00°, 36.8°±1.00°, and 38.6°±1.00° when measuring an X-ray diffraction (XRD) pattern using CuKα rays.

Li₄₊ₓPS₄I₁₊ₓ (−0.1≤x≤0.1) [Formula 1]

When measured by Raman spectroscopy, the particulate solid electrolyte may have a maximum peak at 425.9±0.50 cm⁻¹ and a full width at half maximum (FWHM) of the maximum peak of 6.9±0.50 cm⁻¹.

The particulate solid electrolyte may have a lithium ion conductivity of about 1.0 mS/cm or greater.

In another aspect, provided is an all-solid-state battery including a cathode, an anode, and a solid electrolyte layer disposed between the cathode and the anode, wherein at least one of the cathode, the anode, and the solid electrolyte layer may include the sulfide solid electrolyte described above.

The anode may include a lithium metal.

In additional aspects, vehicles are provided that comprise a battery as disclosed herein.

Other aspects of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows an exemplary all-solid-state battery according to an exemplary embodiment of the present invention;

FIG. 2 shows the results of X-ray diffraction analysis performed on crystalline solid electrolytes in Preparation Examples 1 to 4;

FIG. 3 shows the results of analysis of the mass change before and after heat treatment of the crystalline solid electrolytes in Preparation Examples 1 to 4;

FIG. 4 shows the results of X-ray diffraction analysis performed on the solid electrolytes in Example 2 according to an exemplary embodiment of the present invention and Comparative Example 2;

FIG. 5 shows the results of Raman analysis on the solid electrolytes in Example 2 according to an exemplary embodiment of the present invention and Comparative Example 2;

FIG. 6A shows a cyclic voltammogram of a half cell produced using the solid electrolyte in Example 1 according to an exemplary embodiment of the present invention;

FIG. 6B shows a cyclic voltammogram of a half cell produced using the solid electrolyte in Example 2 according to an exemplary embodiment of the present invention;

FIG. 6C shows a cyclic voltammogram of a half cell produced using the solid electrolyte in Example 3 according to an exemplary embodiment of the present invention;

FIG. 6D shows a cyclic voltammogram of a half cell produced using the solid electrolyte in Example 4 according to an exemplary embodiment of the present invention;

FIG. 6E shows a cyclic voltammogram of a half cell produced using the solid electrolyte in Comparative Example 2; and

FIG. 7 shows a graph showing first charge/discharge of a full cell produced using the solid electrolyte in Example 2 according to an exemplary embodiment of the present invention.

### DETAILED DESCRIPTION

The objects described above, as well as other objects, features, and advantages, will be clearly understood from the following preferred embodiments with reference to the attached drawings. However, the present invention is not limited to the embodiments, and may be embodied in different forms. The embodiments are suggested only to offer a thorough and complete understanding of the disclosed context and to sufficiently inform those skilled in the art of the technical concept of the present invention.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a “first” element may be referred to as a “second” element, and similarly, a “second” element may be referred to as a “first” element. Singular forms are intended to include plural forms as well, unless the context clearly indicates otherwise.

It will be further understood that terms such as “comprise” or “has”, when used in this specification, specify the presence of stated features, integers, steps, operations, elements, components, or combinations thereof, but do not preclude the presence or addition of one or more other features, integers, steps, operations, elements, components, or combinations thereof. In addition, it will be understood that, when an element such as a layer, film, region, or substrate is referred to as being “on” another element, it can be directly on the other element, or an intervening element may also be present. It will also be understood that when an element such as a layer, film, region, or substrate is referred to as being “under” another element, it can be directly under the other element, or an intervening element may also be present.

Unless the context clearly indicates otherwise, all numbers, figures, and/or expressions that represent ingredients, reaction conditions, polymer compositions, and amounts of mixtures used in the specification are approximations that reflect various uncertainties of measurement occurring inherently in obtaining these figures, among other things. For this reason, it should be understood that, in all cases, the term “about” should be understood to modify all such numbers, figures and/or expressions. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numerical ranges are disclosed in the description, these ranges are continuous, and include all numbers from the minimum to the maximum, including the maximum within each range, unless otherwise defined. Furthermore, when a range refers to an integer, it includes all integers from the minimum to the maximum, including the maximum within the range, unless otherwise defined. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In one aspect, methods are provided for preparing a sulfide solid electrolyte, a method suitably comprising: (a) calcining a solid electrolyte precursor to prepare a crystalline solid electrolyte represented by the following formula: Li₄₊ₓPS₄I₁₊ₓ (−0.1≤x≤0.1); and (b) treating the crystalline solid electrolyte to obtain a particulate solid electrolyte. As discussed, the crystalline solid electrolyte suitably may be treated by mechanical force to obtain a particulate solid electrolyte, for example the crystalline solid electrolyte may be pulverized to obtain a particulate solid electrolyte.

In a further aspect, a method of preparing a sulfide solid electrolyte may include providing a solid electrolyte precursor, pulverizing the solid electrolyte precursor, calcining the pulverization product to prepare a crystalline solid electrolyte, and pulverizing the crystalline solid electrolyte to obtain a particulate solid electrolyte.

In the present methods and compositions, the solid electrolyte precursor suitably may include a compound or elemental substance including at least one of lithium (Li), phosphorus (P), sulfur (S) and iodine (I) elements.

Preferably, the solid electrolyte precursor containing a lithium element may suitably include lithium sulfide (Li₂S).

In the present methods and compositions, the solid electrolyte precursor containing a phosphorus element may suitably include phosphorus sulfide such as diphosphorus trisulfide (P₂S₃) and diphosphorus pentasulfide (P₂S₅). The solid electrolyte precursor containing a phosphorus element may preferably include phosphorus sulfide, or particularly diphosphorus pentasulfide.

The solid electrolyte precursor containing an iodine element may preferably include lithium iodide (LiI).

The solid electrolyte precursor suitably may include an elemental lithium metal substance, an elemental phosphorus substance such as red phosphorus, or an elemental sulfur substance.

Any compounds and elemental substances may be used as the compounds and elemental substances as described above without particular limitation, as long as they are industrially manufactured and sold. It is preferable that the compounds and elemental substances have high purity.

The solid electrolyte precursor may be pre-pulverized. Pre-pulverization step may facilitate amorphization of the solid electrolyte in the pulverization described later.

The solid electrolyte precursor may be weighed for the desired composition of the sulfide solid electrolyte, then mixed and pulverized. The pulverization product may be an amorphized solid electrolyte.

There is no particular limitation as to the pulverization of the solid electrolyte precursor, but the pulverization may be performed at about 300 rpm to 500 rpm for about 20 to 30 hours to sufficiently achieve amorphization.

There is no particular limitation as to the method of pulverizing the solid electrolyte precursor, and the pulverization may be performed by, for example, a mortar, a ball mill, a vibration mill, an electric mill, or the like.

The pulverization product is calcined to obtain a crystalline solid electrolyte represented by the following Formula 1:

Li₄₊ₓPS₄I₁₊ₓ (−0.1≤x≤0.1) [Formula 1]

The pulverization product may be calcined at a temperature of about 200° C. to 500° C., or particularly at a temperature of about 300° C. to 400° C. When the calcination temperature is higher than 500° C., the amount of the volatile sulfur component may increase, causing sulfur deficiencies, and excessive precipitation of impurities may occur due to side reactions.

Conventional Li₂S—P₂S₅—LiI sulfide solid electrolytes have low reactivity to lithium metal and are stable, but are inapplicable in practice due to the low lithium ion conductivity thereof when calcined at a high temperature of 300° C. or higher.

In particular, lithium ion conductivity may be increased and interfacial resistance with other components may be lowered by slightly reducing the degree of crystallinity by forming the particulate solid electrolyte from the crystalline solid electrolyte obtained through calcination.

By pulverizing the crystalline solid electrolyte under conditions such that it does not become amorphous, a particulate solid electrolyte may be obtained. Here, the term “particulate solid electrolyte” means a solid electrolyte having an intermediate degree of crystallinity between amorphous and crystalline. For example, “particulate solid electrolyte” may mean a state comprising a crystalline solid electrolyte of about 80% or greater, or about 85% or greater, or about 90% or greater, or about 95% or greater. The % may be based on volume or mass. This can be seen from the results of X-ray diffraction analysis of the particulate solid electrolyte, which will be described later.

By controlling the pulverization speed, pulverization time, etc. of the crystalline solid electrolyte, the crystalline solid electrolyte may be converted into a particulate solid electrolyte rather than an amorphous solid electrolyte. For example, the crystalline solid electrolyte may be pulverized at about 300 rpm to 500 rpm for about 30 minutes to 2 hours.

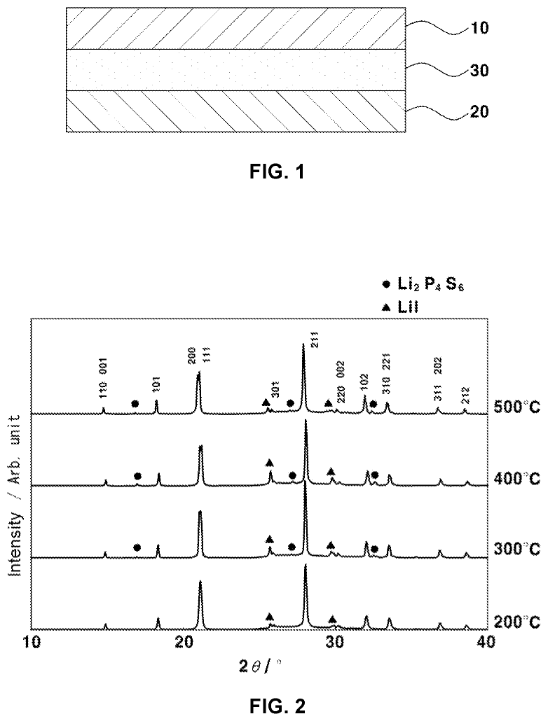

FIG. 1 illustrates a cross-sectional view illustrating an all-solid-state battery according to an exemplary embodiment of the present invention. The all-solid-state battery includes a cathode 10, an anode 20, and a solid electrolyte layer 30 interposed between the cathode 10 and the anode 20. At least one of the cathode 10, the anode 20, and the solid electrolyte layer 30 may include the sulfide solid electrolyte described above.

The cathode 10 may include a cathode active material, a solid electrolyte, a conductive material, a binder, and the like.

The cathode active material may suitably include an oxide active material or a sulfide active material.

The oxide active material may suitably include a rock-salt-layer-type active material such as LiCoO₂, LiNiO₂, LiNi_{0.80}Co_{0.15}Al_{0.05}O₂, LiNi_{1/3}Co_{1/3}Mn_{1/3}O₂, LiNi_{0.5}Co_{0.2}Mn_{0.3}O₂, LiNi_{0.6}Co_{0.2}Mn_{0.2}O₂, LiNi_{0.8}Co_{0.1}Mn_{0.1}O₂, a spinel-type active material such as LiMn₂O₄ or Li(Ni_{0.5}Mn_{1.5})O₄, a reverse-spinel-type active material such as LiNiVO₄ or LiCoVO₄, an olivine-type active material such as LiFePO₄, LiMnPO₄, LiCoPO₄, or LiNiPO₄, a silicon-containing active material such as Li₂FeSiO₄ or Li₂MnSiO₄, a rock-salt-layer-type active material having a transition metal, a portion of which is substituted with a heterogeneous metal such as LiNi_{0.8}Co_{(0.2-x)}AlₓO₂ (0<x<0.2), a spinel-type active material having a transition metal, a portion of which is substituted with a heterogeneous metal such as Li₁₊ₓMn_{2-x-y}M_{y}O₄ (wherein M includes at least one of Al, Mg, Co, Fe, Ni, Zn, and 0<x+y<2), and lithium titanate, such as Li₄Ti₅O₁₂.

The sulfide active material may suitably include copper Chevrel, iron sulfide, cobalt sulfide, nickel sulfide, or the like.

The cathode active material may be coated with LiNbO₃, Li₂TiO₃, Li₂ZrO₃ or the like.

The solid electrolyte may suitably include a sulfide solid electrolyte prepared according to the present invention, but is not limited thereto. The solid electrolyte may suitably include a solid electrolyte such as Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn, and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), or Li₁₀GeP₂Si₂.

The conductive material may suitably include carbon black, conductive graphite, ethylene black, graphene, or the like.

The binder may suitably include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC) or the like.

In an exemplary embodiment, the anode 20 may include an anode active material, a solid electrolyte, a binder, and the like.

The anode active material may suitably include a carbon active material or a metal active material, but is not particularly limited thereto.

The carbon active material may suitably include graphite, such as mesocarbon microbeads (MCMB) or highly oriented pyrolytic graphite (HOPG), or amorphous carbon, such as hard carbon or soft carbon.

The metal active material may suitably include In, Al, Si, Sn, an alloy containing at least one of these elements, or the like.

The solid electrolyte may suitably include a sulfide solid electrolyte prepared according to the present invention, but is not limited thereto. The solid electrolyte may include a solid electrolyte such as Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn, and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), or Li₁₀GeP₂Si₂.

The binder may suitably include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

In an exemplary embodiment, the anode 20 may suitably include a lithium metal or lithium alloy.

The lithium metal may suitably include lithium foil or the like.

The lithium alloy may suitably include an alloy of lithium, and a metal or metalloid that can be alloyed with lithium.

The metal or metalloid that may be alloyed with lithium may suitably include Si, Sn, Al, Ge, Pb, Bi, Sb, or the like.

The solid electrolyte layer 30 is interposed between the cathode 10 and the anode 20 to allow lithium ions to move between the two electrodes.

The solid electrolyte layer 30 may include a solid electrolyte, a binder, and the like.

The solid electrolyte may suitably include a sulfide solid electrolyte prepared according to the present invention, but is not limited thereto. The solid electrolyte may include a solid electrolyte such as Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn, and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), or Li₁₀GeP₂S₁₂.

The binder may suitably include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

### EXAMPLE

Hereinafter, the present invention will be described in more detail with reference to specific examples. However, the following examples are provided only for better understanding of the present invention, and thus should not be construed as limiting the scope of the present invention.

### Preparation Examples 1 to 4

As solid electrolyte precursors, 0.3297 g of lithium sulfide (Li₂S, Mitsuwa Chemicals Co., Ltd.), 0.5366 g of diphosphorus pentasulfide (P₂S₅), and 0.6398 g of lithium iodide (LiI, Alfa Aesar) were weighed and provided. The lithium sulfide and lithium iodide were pre-pulverized. The lithium sulfide was pulverized at 370 rpm for 30 hours using a ball mill, and the lithium iodide was pulverized at 370 rpm for 15 hours using a ball mill. During pre-pulverization, the ball mill was placed in a stainless steel container and completely sealed to prevent exposure of the substances to the atmosphere.

The solid electrolyte precursor prepared as described above was placed in a 45 ml zirconium oxide container, and 10 zirconia balls having a diameter of about 10 mm were placed therein. The ball mill was completely sealed as in the pre-grinding and then the solid electrolyte precursor was pulverized and mixed at 370 rpm for 15 hours.

The pulverized material was collected and put into a graphite crucible. An electric furnace was placed in a glove box in an argon gas atmosphere and the graphite crucible was placed into the glove box. After elevating the temperature to a temperature of 200° C. (Preparation Example 1), 300° C. (Preparation Example 2), 400° C. (Preparation Example 3), and 500° C. (Preparation Example 4) at a temperature increase rate of 2.0° C./min, calcination was performed at each temperature for about 10 hours to prepare a crystalline solid electrolyte.

X-ray diffraction analysis was performed on the crystalline solid electrolytes according to Preparation Examples 1 to 4. The results are shown in FIG. 2. It can be seen from FIG. 2 that the crystalline solid electrolyte contained Li₄PS₄I as the main crystalline phase and a small amount of LiI. Meanwhile, in Preparation Examples 2 to 4, a small amount of an Li₂P₄S₆ impurity phase was present, because the sintering was performed at a slightly high temperature of 300° C. or higher.

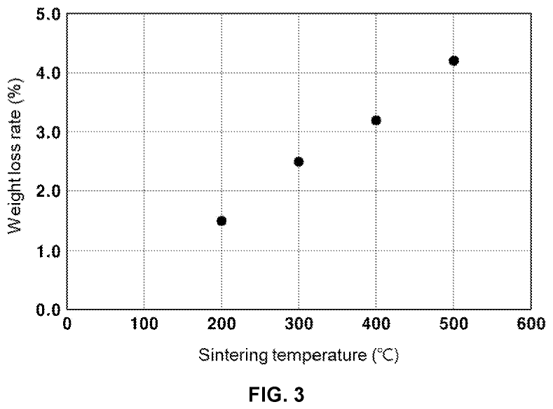

The mass change before and after heat treatment of the crystalline solid electrolytes according to Preparation Examples 1 to 4 was analyzed. The results are shown in FIG. 3. It can be seen from FIG. 3 that as the calcination temperature increased, the amount of the volatile sulfur component increased, causing a sulfur deficiency. However, the mass change rate of Preparation Examples 1 to 4 was less than 5%, which does not affect physical properties such as lithium ion conductivity.

### Examples 1 to 4

The crystalline solid electrolytes in Preparation Examples 1 to 4 were placed in a 45 ml zirconium oxide container, and 10 zirconia balls having a diameter of about 10 mm were placed therein. The ball mill was completely sealed and then the crystalline solid electrolytes were pulverized and mixed at 370 rpm for 1 hour to obtain particulate solid electrolytes according to Examples 1 to 4.

### Comparative Examples 1 to 4

The crystalline solid electrolytes in Preparation Examples 1 to 4, which were not converted to particulate solid electrolytes, were used as the solid electrolytes according to Comparative Examples 1 to 4.

### Experimental Example 1

The ionic conductivity of each of the solid electrolytes in Examples 1 to 4 and Comparative Examples 1 to 4 was measured. Each solid electrolyte was compression-molded to form a molded product for testing (diameter of 13 mm, thickness of 0.4 to 1.0 mm). Ionic conductivity was measured by applying an alternating current of 10 mV to the molded product, conducting a frequency sweep at 7×10⁶ to 0.1 Hz, and measuring an impedance value. The results are shown in the following Table 1.

TABLE 1

| | | | Lithium ion |
|---|---|---|---|
| | Calcination | Conversion | conductivity |
| Item | temperature [° C.] | to particles | [mS/cm] |
| Example 1 | 200 | ◯ | 1.24 |
| Example 2 | 300 | ◯ | 1.68 |
| Example 3 | 400 | ◯ | 1.62 |
| Example 4 | 500 | ◯ | 1.24 |
| Comparative | 200 | X | 0.08 |
| Example 1 | | | |
| Comparative | 300 | X | 0.04 |
| Example 2 | | | |
| Comparative | 400 | X | 0.04 |
| Example 3 | | | |
| Comparative | 500 | X | 0.06 |
| Example 4 | | | |

It can be seen from Table 1 above that all of the particulate solid electrolytes according to Examples 1 to 4 had lithium ion conductivity of 1.0 mS/cm or greater, which was much higher than that of the crystalline solid electrolytes in Comparative Examples 1 to 4.

### Experimental Example 2

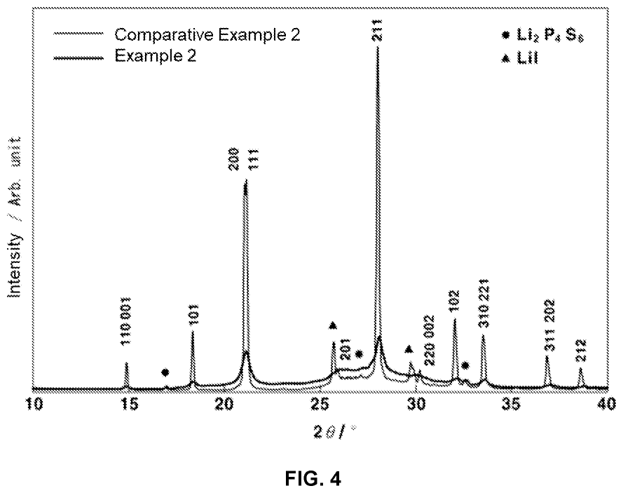

The solid electrolytes in Example 2 and Comparative Example 2 were subjected to X-ray diffraction analysis. The results are shown in FIG. 4. It can be seen from FIG. 4 that the solid electrolyte according to Example 2 had peaks at 2θ=14.9°±0.50°, 18.3°±0.50°, 21.1°±0.50°, 28.0°±0.50°, 32.0°±0.50°, 33.5±1.00°, 36.8°±1.00° and 38.6°±1.00°. It can be seen therefrom that the particulate solid electrolyte according to the present invention was not amorphous but crystalline. On the other hand, compared to the solid electrolyte in Comparative Example 2, the solid electrolyte according to Example 2 had a decreased intensity of peak and an increased full width at half maximum (FWHM) of the peak, which indicates that crystallinity decreased.

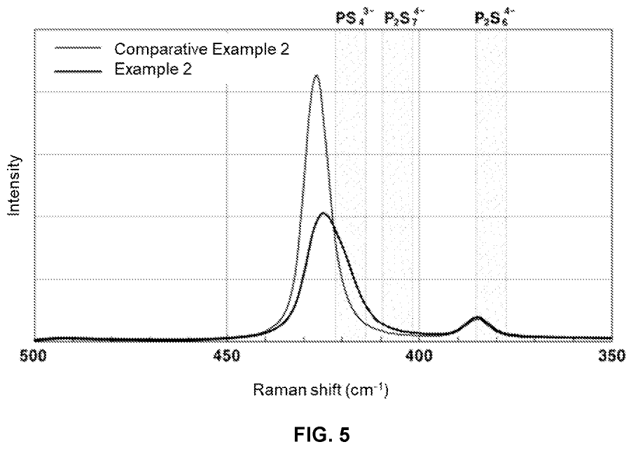

Raman analysis was performed on the solid electrolytes in Example 2 and Comparative Example 2. The results are shown in FIG. 5. As can be seen from FIG. 5, the solid electrolytein Example 2 had a maximum peak at 425.9±0.50 cm′ and a full width at half maximum (FWHM) of the maximum peak of 6.9±0.50 cm′. On the other hand, the solid electrolyte in Comparative Example 2 had a maximum peak at 426.7±0.50 cm′ and a full width at half maximum (FWHM) of the maximum peak of 5.5±0.50 cm′. In summary, the position of the center of the maximum peak of the particulate solid electrolyte according to the present invention was shifted by −0.5 cm⁻¹ or more from the position of the center of the maximum peak of the crystalline solid electrolyte, and the full width at half maximum (FWHM) of the maximum peak of the particulate solid electrolyte was increased by 20% or greater compared to the full width at half maximum (FWHM) of the maximum peak of the crystalline solid electrolyte. This showed that a deterioration in crystallinity and non-uniformity of the PS₄³⁻ unit structure occurred in the particulate solid electrolyte according to the present invention, and this non-uniformity of the crystal structure advantageously acts on lithium ion conductivity.

### Experimental Example 2

Solid electrolyte layers were formed using the solid electrolytes in Examples 1 to 4 and Comparative Example 2, a current collector made of SUS was adhered to one surface of each solid electrolyte, and a piece of lithium foil was adhered to the other surface thereof to produce a half cell. When the half-cell was potential swept in the negative direction up to −0.1V, lithium was deposited between the solid electrolyte layer and the current collector. Subsequently, the half-cell was potential swept in the positive direction up to 3V, and the lithium was melted.

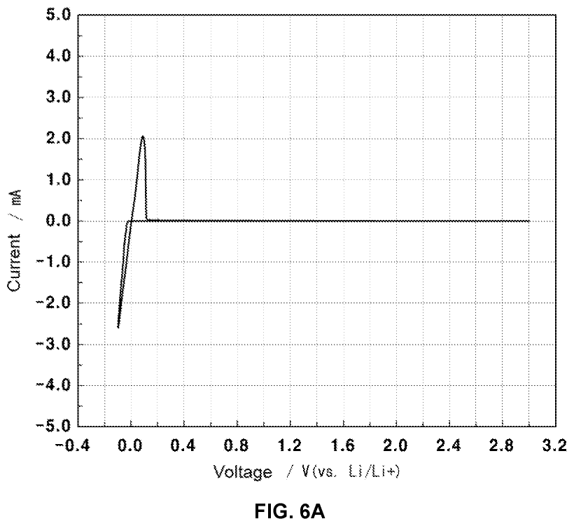

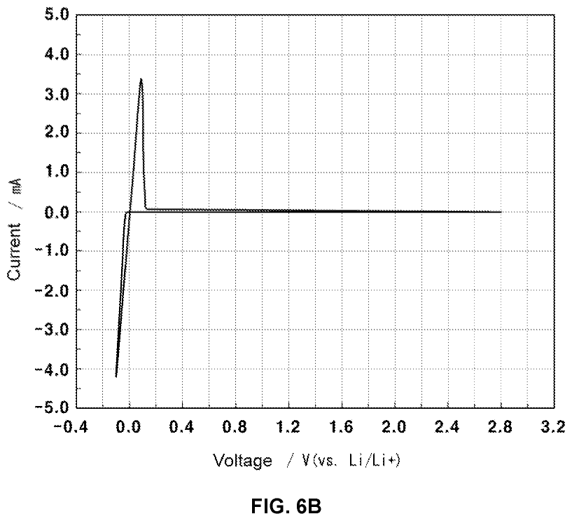

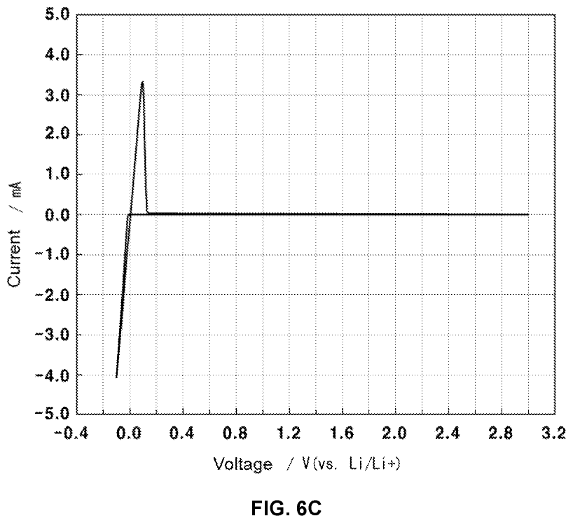

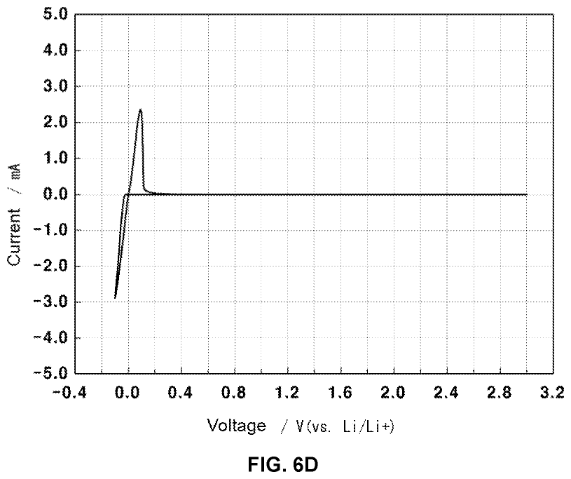

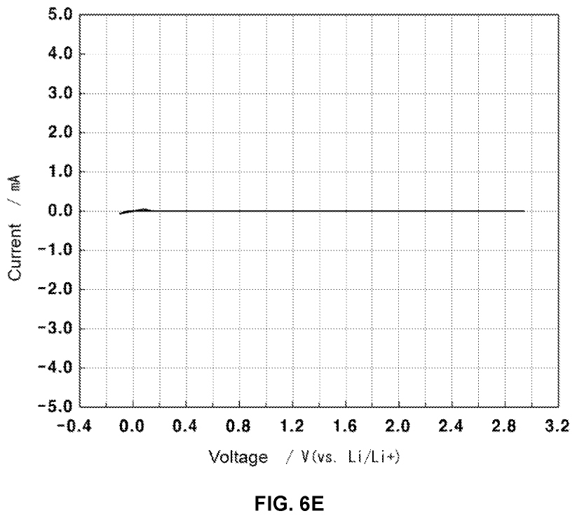

FIGS. 6A to 6E are cyclic voltammograms of half cells prepared using the solid electrolytes in Examples 1 to 4 and Comparative Example 2, respectively. As can be seen from FIG. 6E, in Comparative Example 2, which was a crystalline solid electrolyte that had not been converted to a particulate solid electrolyte, lithium deposition and melting at room temperature were expected to be difficult due to the low lithium ion conductivity. On the other hand, it can be seen that all of the half-cells produced using the particulate solid electrolytes in Examples 1 to 4 shown in FIGS. 6A to 6D are expected to facilitate lithium precipitation and melting. In particular, as the heat treatment temperature increases, it can be seen that the insulating elemental sulfur substance remaining in the solid electrolyte precursor is removed, so the lithium deposition and melting increase.

### Experimental Example 3

A solid electrolyte layer was formed using the solid electrolyte in Example 2, an cathode containing an cathode active material was adhered to one surface of the solid electrolyte, and a piece of lithium foil was adhered to the other surface thereof to produce a half cell. The cathode active material used herein was LiNi_{0.8}Co_{0.1}Mn_{0.1}O₂ coated with LiNbO₃.

In contrast, a half cell was produced in the same manner as above except that an LPSX-based solid electrolyte having an argyrodite-based crystal structure was used for the solid electrolyte layer. The half cell was set as a reference example.

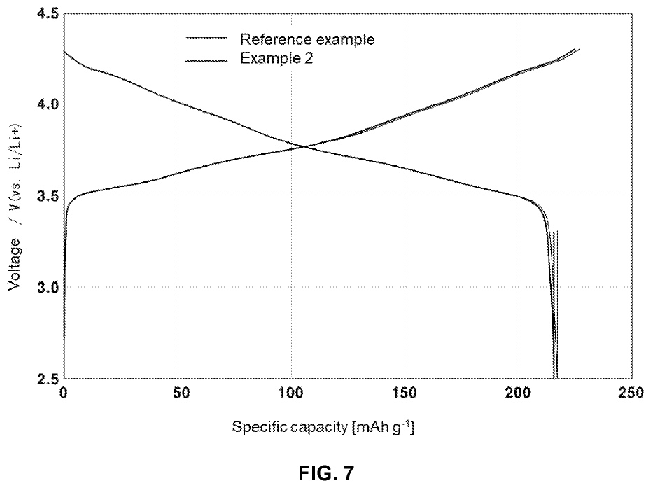

FIG. 7 shows a graph showing first charge/discharge of each full cell. As can be seen from FIG. 7, the all-solid-state battery using the particulate solid electrolyte according to Example 2 exhibits the same charge/discharge capacity as the sulfide solid electrolyte having an argyrodite-based crystal structure.

According to various exemplary embodiments of the present invention, a sulfide solid electrolyte having excellent lithium ion conductivity can be obtained.

According to various exemplary embodiments of the present invention, a sulfide solid electrolyte capable of remarkably reducing interfacial resistance with other components can be obtained.

The effects of the present invention are not limited to those mentioned above. It should be understood that the effects of the present invention include all effects that can be inferred from the description of the present invention.

The present invention has been described in detail with reference to embodiments thereof. However, it will be appreciated by those skilled in the art that changes may be made in these embodiments without departing from the principles and spirit of the present invention, the scope of which is defined in the appended claims and their equivalents.

What is claimed is:

1. A method of preparing a sulfide solid electrolyte, comprising:
calcining a solid electrolyte precursor to prepare a crystalline solid electrolyte represented by Formula 1
Li₄₊ₓPS₄I₁₊ₓ (−0.1≤x≤0.1); and [Formula 1]
treating the crystalline solid electrolyte to obtain a particulate solid electrolyte.

2. A method of preparing a sulfide solid electrolyte, comprising:
pulverizing a solid electrolyte precursor;
calcining the pulverized solid electrolyte precursor to prepare a crystalline solid electrolyte represented by Formula 1
Li₄₊ₓPS₄I₁₊ₓ (−0.1≤x≤0.1); and [Formula 1]
pulverizing the crystalline solid electrolyte to obtain a particulate solid electrolyte.

3. The method according to claim 2, wherein the solid electrolyte precursor comprises a compound or elemental substance comprising at least one of lithium (Li), phosphorus (P), sulfur (S), and iodine (I) elements.

4. The method according to claim 2, wherein the pulverized solid electrolyte precursor is calcined at a temperature of about 200° C. to 500° C.

5. The method according to claim 2, wherein the crystalline solid electrolyte is converted to a particulate solid electrolyte through pulverization at about 300 rpm to 500 rpm for about 10 minutes to 2 hours.

6. The method according to claim 1, wherein, when measured by Raman spectroscopy, a position of a center of a maximum peak of the particulate solid electrolyte is shifted by about −0.5 cm⁻¹ or greater from a position of a center of a maximum peak of the crystalline solid electrolyte.

7. The method according to claim 2, wherein, when measured by Raman spectroscopy, a position of a center of a maximum peak of the particulate solid electrolyte is shifted by about −0.5 cm⁻¹ or greater from a position of a center of a maximum peak of the crystalline solid electrolyte.

8. The method according to claim 1, wherein, when measured by Raman spectroscopy, a full width at half maximum (FWHM) of the maximum peak of the particulate solid electrolyte increases by about 20% or greater compared to a full width at half maximum (FWHM) of the maximum peak of the crystalline solid electrolyte.

9. The method according to claim 1, wherein, when measured by Raman spectroscopy, the particulate solid electrolyte has a maximum peak at 425.9±0.50 cm⁻¹ and a full width at half maximum (FWHM) of the maximum peak of 6.9±0.50 cm⁻¹.

10. The method according to claim 1, wherein the particulate solid electrolyte has peaks at 2θ=14.9°±0.50°, 18.3°±0.50°, 21.1°±0.50°, 28.0°±0.50°, 32.0°±0.50°, 33.5±1.00°, 36.8°±1.00°, and 38.6°±1.00° when measuring an X-ray diffraction (XRD) pattern using CuKα rays.

11. The method according to claim 1, wherein the particulate solid electrolyte has a lithium ion conductivity of about 1.0 mS/cm or greater.

12. A sulfide solid electrolyte corresponding to Formula 1
Li₄₊ₓPS₄I₁₊ₓ (−0.1≤x≤0.1); and [Formula 1]
and having peaks at 2θ=14.9°±0.50°, 18.3°±0.50°, 21.1°±0.50°, 28.0°±0.50°, 32.0°±0.50°, 33.5±1.00°, 36.8°±1.00°, and 38.6°±1.00° when measuring an X-ray diffraction (XRD) pattern using CuKα rays.

13. The sulfide solid electrolyte according to claim 12, wherein, when measured by Raman spectroscopy, the particulate solid electrolyte has a maximum peak at 425.9±0.50 cm⁻¹ and a full width at half maximum (FWHM) of the maximum peak of 6.9±0.50 cm⁻¹.

14. The sulfide solid electrolyte according to claim 12, wherein the particulate solid electrolyte has a lithium ion conductivity of about 1.0 mS/cm or greater.

15. An all-solid-state battery comprising:
a cathode;
an anode; and
a solid electrolyte layer disposed between the cathode and the anode,
wherein at least one of the cathode, the anode, and the solid electrolyte layer comprises the sulfide solid electrolyte according to claim 12.

16. The all-solid-state battery according to claim 15, wherein the anode comprises a lithium metal.

17. A vehicle comprising a battery of claim 15.
